(19) United States
(12) Patent Application Publication
(10) Pub. No.: US 2011/0032996 A1
(43) Pub. Date: Feb. 10, 2011

(54) USING DUAL HDVICP COPROCESSOR TO ACCELERATE DM6467 H.264 DECODER

(75) Inventor: Kui Zhang, Austin, TX (US)

Correspondence Address: WONG, CABELLO, LUTSCH, RUTHERFORD & BRUCCULERI,;L.L.P., 20333 SH 249 6th Floor, HOUSTON, TX, 77070, US

(73) Assignee: Polycom, Inc., Pleasanton, CA (US)

(21) Appl. No.: 12/535,494

(22) Filed: Aug. 4, 2009

(51) Int. Cl. H04N 7/26

(52) U.S. Cl. 375/240.25; 375/E07.027

(57) ABSTRACT

Systems and methods are disclosed for utilizing multiple co-processors, of a multiprocessor processing device, in tandem to improve performance for H.264 video decoding operations. The video decoding operation may be split across the multiple High Definition Video Image Co-Processors (HDVICPs) of a multiprocessor device such as Texas Instrument's DM6467 utilizing a spatially shifted temporal split to improve overall performance of the video decoding operation while conforming to the H.264 standard.

### FIELD OF THE DISCLOSURE

This disclosure relates generally to the field of video conferencing. More particularly, but not by way of limitation, this disclosure is directed to a method of utilizing multiple High Definition Video Image Co-Processors (HDVICPs) for H.264 decoding with improved performance.

### BACKGROUND

Video data encoding is the process of preparing video input data and optionally compressing the data for storage or transmission to a video decoder. The decoder can then prepare and reconstruct the original input data to a certain resolution for output on a video display device. The digital video data is encoded to meet proper formats and specifications for recording and playback through the use of video encoder software and firmware. Digital video data is used in many different fields including video conferencing, web broadcasting, television broadcasting, digital versatile discs (DVDs) for education and entertainment as well as many other fields. To properly reproduce digital video on display devices produced by different vendors the decoders of these devices must be able to understand how to decode the supplied data. One method of accomplishing this requirement is through standards for video data compression (part of encoding) such as H.261, H.263, MPEG-2, MPEG-4 and H.264.

H.264/AVC is an international video coding standard promulgated by the Telecommunication Standardization Sector (ITU-T) for video coding telecommunication applications. It is a joint effort between ITU-T and ISO-MPEG (Motion Picture Expert Group of International Standard Organization), and it was the product of a partnership effort known as the Joint Video Team (JVT). AVC stands for Advanced Video Codec. The scope of H.264/AVC standardization is limited only to the central decoder. The standard imposes restrictions on the bitstream and syntax, and defines the decoding process via syntax elements such that every decoder conforming to the standard will produce similar output when given an encoded bitstream. Therefore, maximal freedom to optimize implementations in a manner appropriate to specific applications may be achieved.

A key component of the H.264 standard is the use of reference frames. H.264 supports multi-picture inter-picture prediction, which utilizes previously-decoded pictures as references when decoding a current prediction frame. This kind of prediction tries to take advantage of the temporal redundancy between neighboring frames and achieve higher compression ratio. Because of this compression technique, prediction frames of a video sequence cannot be decoded without first decoding reference frames (or corresponding portion thereof) from which to start. The reference frames can either be I-frames or P-frames. I-frames are sometimes referred to as key frames are strictly intra coded (every block is coded using raw pixel values or predicted from adjacent pixel values), only with references to itself, so it can always be decoded without additional information from other frames. Also, each frame of the encoded stream (that is not a reference frame) must be decoded substantially in the same order they were encoded. In addition to I-frames, P-frames can also be used as reference frames. A P-frame is a predictive video frame that only stores the data that has changed from the preceding I-frame or P-frames. Apart from I-frames and P-frames, there are B-frames. A B-frame is what is known as a delta frame because it relies on changes from the frame before or after it. B-frames cannot be used as reference frames. H.264 baseline profile only uses I-frames and P-frames. Both spatial prediction and temporal prediction are utilized by the H.264 standard. Spatial prediction utilizes pixels from adjacent blocks to improve coding efficiency while temporal prediction utilizes pixels from previous frames to improve coding efficiency.

The TMS320DM6467 (DM6467) is a single chip, multi-format, real-time high definition (HD) video transcoding solution for commercial and consumer end equipment provided by Texas Instruments Corporation of Dallas, Tex. A block diagram of an exemplary DM6467 (100) is shown in FIG. 1. The DM6467 100 has a digital signal processor (DSP) 110 a central processing unit (CPU) 120 and two HD Video Image Co-Processors (HD-VICP) 130. The exemplary DM6467 (100) shown in FIG. 1 has a DSP (110) core speed of 600 MHz and CPU (120) and HDVICP (130) clock speeds of ½ the DSP core speed (i.e., 300 MHz). Those of ordinary skill in the art will recognize that different clock speeds are possible without re-designing a chip. Also, the relative speeds of the different co-processors on a particular chip should remain proportional to each other as the overall speed of the chip is increased. In other words, a DM6467 with a DSP core speed of 800 MHz would have two HDVICPs each with a clock speed of 400 MHz.

Several prior art decoding techniques for multiple core processors are possible. These prior art decoding techniques include spatial splitting (FIG. 2A), functional splitting (FIG. 2B), and temporal splitting (FIG. 2C). Each of these techniques will be discussed in turn.

In a spatial split (shown in FIG. 2A) each core will work on part of an image frame. A popular spatial split is to split an image frame into multiple slices and have each core work on a slice of the same image frame at substantially the same time. The advantages of this technique include: low delay, easy implementation, and minimal inter-core communication. The disadvantages of spatial splitting include: visible artifacts, and spatial continuity may be lost along a slice boundary which may also cause lower coding efficiency.

Referring now to FIG. 2A, a block diagram is shown representing a prior art spatial split of a single frame of H.263 decoding divided amongst multiple co-processors. In this example, each of three co-processors concurrently work on three distinct segments of a single frame (i.e., top on Co-Processor (CP) 0, middle on CP 1, and bottom on CP 2). In this manner, each of the CPs is responsible for calculating approximately ⅓ of each result frame. However, the complexity of the different frame portions may not be balanced and thus splitting the image into three portions may not result in optimal efficiency for the overall decoding process. Due to the use of both spatial and temporal prediction in H.264 standard, spatial split cannot be used to produce a standard conforming H.264 decoder.

Another technique is a functional split (shown in FIG. 2B) which may be utilized if the image cannot be divided into multiple slices such that each core can work independently (such as in H.264 decoding). In a functional split the decoding task can be divided into two or more relatively balanced functional units. Each functional unit will take a previous unit's output as its input. The advantages of functional splitting include: flexibility, and no loss of coding efficiency due to spatial discontinuity. The disadvantages of functional splitting include: latency and complexity. The complexity is, in part, due to the difficulty of evenly splitting each functional task. Therefore, imbalance among different cores is a common issue. When the number of cores increases, it may be increasingly difficult to split a decoding task into relatively equal functional units. Also, there may be heavy inter-core communication from sharing a previous unit's output.

Referring now to FIG. 2B, a block diagram is shown representing a prior art functional split of a single frame of H.264 decoding divided amongst multiple CPs. In this example, each of three CPs concurrently work on three distinct functional segments of a single frame (i.e., functional unit 1 on CP 0, functional unit 2 on CP 1, functional unit 3 on CP 2). In this manner, each of the CPs is again responsible for calculating approximately ⅓ of each result frame. However, the complexity of splitting the image or decoding process into equal functional parts may not result in optimal efficiency for the overall encoding and decoding process.

Finally, a third technique is a temporal split (shown in FIG. 2C). The temporal split is similar to the functional split. However, instead of splitting the work by functional units, different cores will work on different image frames concurrently. The advantages of temporal splitting include: easy implementation, and minimal inter-core communications. The disadvantages of temporal splitting include: latency, temporal discontinuity (which may reduce coding efficiency performed by the encoder), and it may not be possible to use this technique on a decoder unless a temporal reference group is known.

Referring now to FIG. 2C, a block diagram is shown representing a prior art temporal split decoding technique where each CP decodes an entire frame. In this example CP 0 decodes frame 0 at the same time that CP 1 decodes frame 1 and so on. That is, given 3 CPs each of them will entirely decode every third frame in turn. However, in this technique temporal discontinuity may reduce coding efficiency performed by the encoder and it may not be possible to use this technique on a decoder unless a temporal reference group is known. Recall that modern video compression algorithms require a reference image to use in the decoding process (except for I-frames).

Video displays are capable of displaying video images at different display resolutions. The display resolution of a digital television or display typically refers to the number of distinct pixels in each dimension that can be displayed. The term “display resolution” is usually used to mean pixel dimensions (e.g., 1280×1024). Currently televisions are of the following resolutions:
SDTV: 480i (NTSC, 720×480 split into two 240-line fields)
SDTV: 576i (PAL, 720×576 split into two 288-line fields)
EDTV: 480p (NTSC, 720×480)
EDTV: 576p (PAL, 720×576)
HDTV: 720p (1280×720)
HDTV: 1080i (1280×1080, 1440×1080, or 1920×1080 split into two 540-line fields)
HDTV: 1080p (1920×1080 progressive scan)

Although there is not a unique set of standardized image/picture sizes, it is common place within motion picture industry to refer to “nK” image “quality”, where n is a (small, usually even) integer number which translates into a set of actual resolutions, depending on the film format. As a reference consider that, for a 4:3 (around 1.33) aspect ratio which a film frame (no matter what is its format) is expected to horizontally fit in, n is the multiplier of 1024 such that the horizontal resolution is exactly 1024n points. For example, 2K reference resolution is 2048×1536 pixels, whereas 4K reference resolution is 4096×3072 pixels. Nevertheless, 2K may also refer to resolutions like 2048×1556, 2048×1080 or 2048×858 pixels, whereas 4K may also refer to 4096×3112, 3996×2160 or 4096×2048 resolution.

Currently, H.264 decoders running on a DM6467 are only capable of decoding resolutions of 1080p30 (i.e., 1080 progressive scan resolution at 30 frames per second) or 1080i60 (i.e., 1080 interlaced at 60 frames per second). This limitation is because of several performance issues (e.g., PCI bandwidth limitation, clock speed of DM6467) and prior art multi core H.264 decoding techniques (such as functional split) cannot be effectively utilized due to hardware constraints. What is needed is a system and method to utilize two or more HDVICP's concurrently while decoding H.264 such that the decoder can deliver 1080p60 and 4K resolution while properly accounting for H.264 spatial and temporal constraints.

### SUMMARY

In one embodiment, a method of decoding H.264 compliant data via a programmable control device comprising a plurality of video image coprocessors (e.g., CP 0 and CP 1) is disclosed. In this embodiment, the programmable control device is programmed to decode H.264 compliant data. The decoding process utilizes a temporal split such that CP 0 decodes even numbered frames and CP 1 decodes odd numbered frames. This temporal split is combined with a spatial shift such that each CP will start its decoding process only when the portion of the reference frame has already been decoded by another CP. In a two way split, when the top portion of a first even numbered frame on CP 0 was decoded, the results are made available to CP 1 as a portion of the reference frame for decoding the top portion of a first odd numbered frame while CP 0 continues work on the bottom portion of the first even numbered frame. Those of ordinary skill in the art will recognize, given the benefit of this disclosure, that the specific order of decoding the different portions may have many combinations and permutations. However, it is important to insure that a corresponding reference frame is made available to one CP while the other CP decodes another portion concurrently.

In another embodiment, a video playback device is configured with a programmable control device. The programmable control device comprises a plurality of video image coprocessors (e.g., CP 0 and CP 1). The programmable control device is programmed to decode H.264 compliant data. The decoding process utilizes a temporal split such that CP 0 decodes even numbered frames and CP 1 decodes odd numbered frames. This temporal split is combined with a spatial shift such that each CP first decodes the top portion of the frame and then in the next cycle decodes the bottom portion of the same frame. By decoding a top portion of a first even numbered frame on CP 0 the results are made available to CP 1 as a reference frame for decoding the top portion of a first odd numbered frame at the same time that CP 0 begins work on the bottom portion of the first even numbered frame. Alternate embodiments of spatially shifted temporal split combinations are also disclosed.

In yet another embodiment, a video conferencing device is configured with a programmable control device and a network interface. The network interface is configured to communicate with other conferencing devices and the programmable control device is configured to decode H.264 compliant data in accordance with other embodiments disclosed herein.

### BRIEF DESCRIPTION OF THE DRAWINGS

FIG. 1 shows, in block diagram form, a TMS320DM6467 processor block diagram with multiple high definition video/imaging co-processors (HDVICPs).

FIGS. 2A-C show, in block diagram form, several prior art decoding techniques.

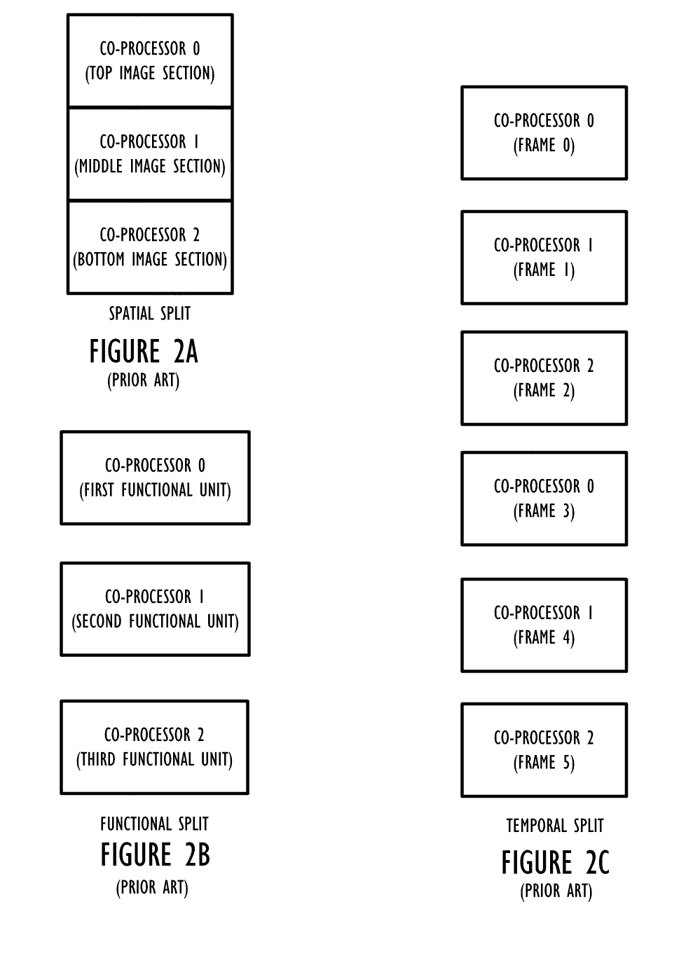

FIGS. 3A-B show embodiments of this disclosure via timing diagrams of exemplary H.264 compliant decoding techniques.

FIG. 4 shows, in block diagram form, an exemplary video decoding device comprising a programmable control device which may be configured according to disclosed embodiments.

### DETAILED DESCRIPTION

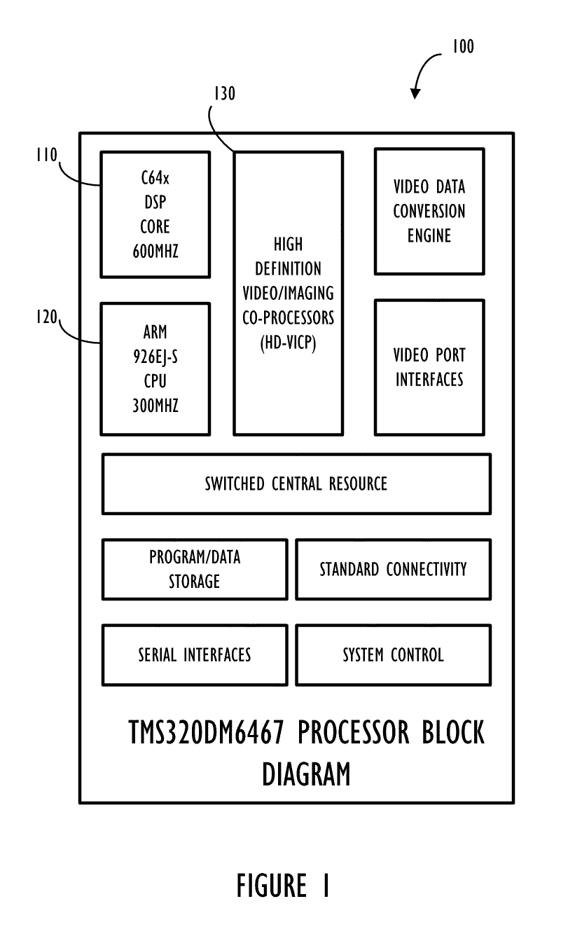

Methods, devices and systems to allow for 1080p60 high definition video decoding using multiple video co-processors are disclosed. FIG. 1 shows a block diagram of an exemplary DM6467 (100). The DM6467 100 has a digital signal processor (DSP) 110 a central processing unit (CPU) 120 and two HD Video Image Co-Processors (HD-VICP) 130. The exemplary DM6467 (100) shown in FIG. 1 has a DSP (110) with a clock speed of 600 MHz. Each of CPU (120) and HDVICP (130) have clock speeds of ½ the DSP clock speed (i.e., 300 MHz). Those of ordinary skill in the art will recognize that different processor clock speeds are possible but the relative speeds of the different co-processors on a single chip should remain proportional in each design. Also, the embodiments disclosed herein are described relative to the DM6467 (100). However, given the benefit of this disclosure, those of ordinary skill in the art would recognize that other multi-processor chips may perform the embodiments disclosed herein.

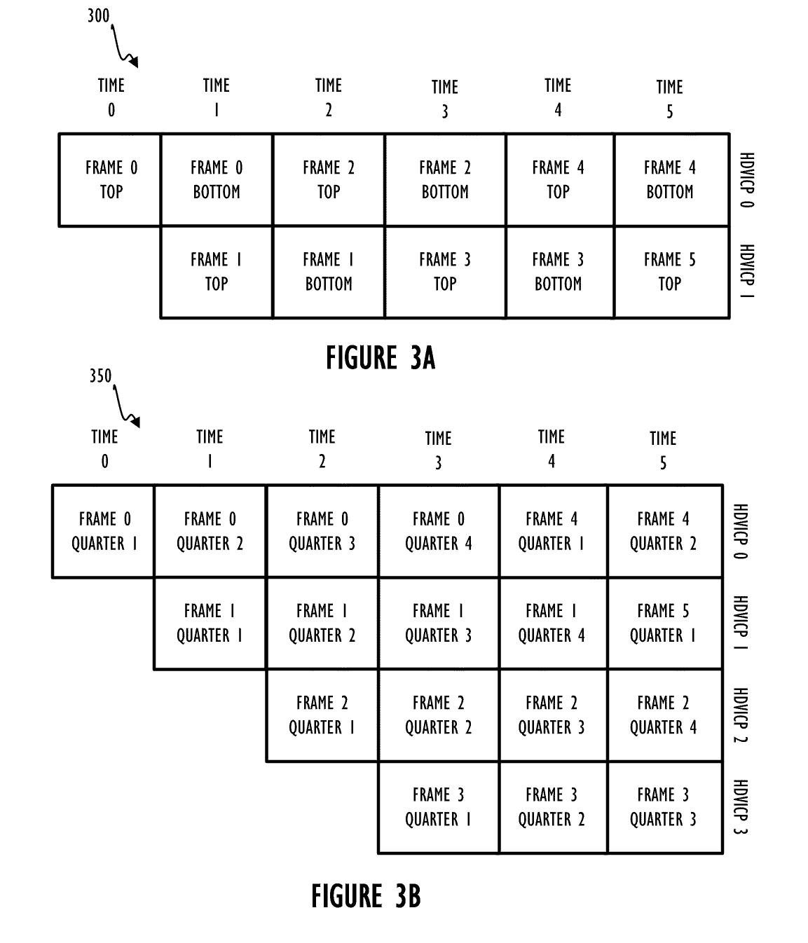

Referring now to FIG. 3A, a timing diagram showing a temporal split used in conjunction with a spatial shift in accordance with one embodiment of this disclosure. At time 0 (T0) the top portion of frame 0 is decoded on CP 0. Next at T1, the bottom portion of frame 0 is decoded on CP 0 concurrently with CP 1 decoding the top portion of frame 1. In this manner, both CPs are used for decoding. CP 0 is utilized to decode even numbered frames (i.e., 0, 2, 4, etc.) and CP 1 decodes odd numbered frames (i.e., 1, 3, 5, etc.). Because of the combination of spatial shift with temporal split, by the time that CP 1 decodes frame 1's top zone, frame 0's top zone is already available as the reference image. Likewise, when CP 0 is ready to decode frame 2's top zone, CP 1 has already finished decoding frame 1's top zone so that it can be used as frame 2's reference image.

Although the spatially shifted temporal split shown in FIG. 3A has been shown across two CPs, those of ordinary skill in the art, given the benefit of this disclosure, will recognize that other divisions are possible relative to the number of CPs available for use. These other divisions may include combinations of temporal, spatial and functional splitting expanding on the example described in FIG. 3A.

For example as shown in FIG. 3B, a four way spatial split of an image into quadrants and dividing the decoding process across four CPs using a four way horizontal split (i.e., into four (4) quarters or quadrants). In this four way split example, CP 0 decodes the first quadrant of frame 0 at T0. At T1, CP 1 decodes the first quadrant of frame 1 using the results just completed from CP 0 (frame 0 quadrant 1) as a reference frame. Also at T1, CP 0 decodes the second quadrant of frame 0. At T2, CP 2 begins work on frame 2 while CP 0 and CP 1 continue working on successive quadrants of their respective frames. In this way the frames are split evenly across the four processors. This enhanced splitting technique may achieve even higher throughput of the overall decoding process. Additionally, if a four way split is to be used on a 1080p image, there may be restrictions imposed on the Maximum Vertical MC component range (MaxVmvR). Generally speaking, if the height of the split is less than the MaxVmvR specified in the standard then MaxVmvR may need to be renegotiated through external means.

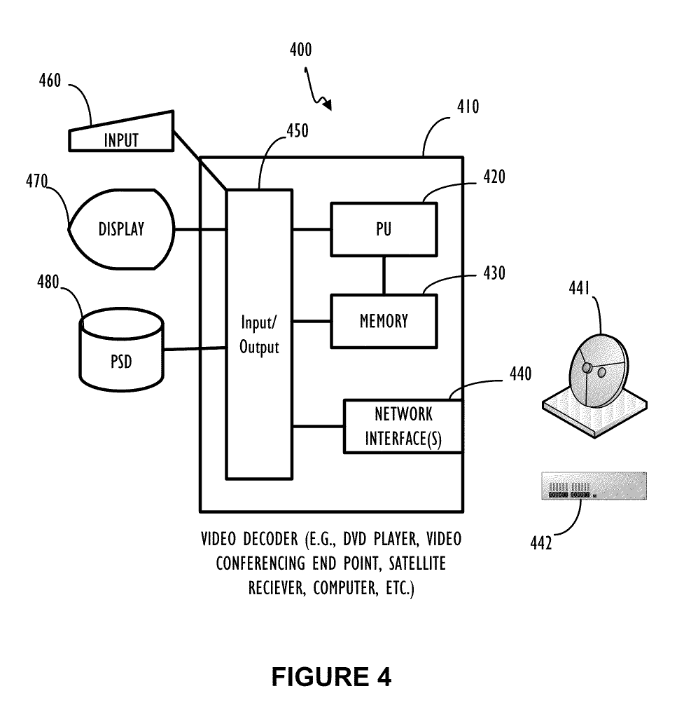

Referring now to FIG. 4, an exemplary video decoding device 400 is shown. Exemplary video decoding device 400 comprises a programmable control device 410 which may be optionally connected to input 460 (e.g., remote control, keyboard, mouse, touch screen, etc.), display 470 or program storage device (PSD) 480. Also, included with program control device 410 is one or more optional network interface(s) 440 for communication via a network with other devices (not shown). Note network interface 440 may be included within programmable control device 410 or be external to programmable control device 410. In either case, when network optional network interface 440 is available, programmable control device 410 will be communicatively coupled to network interface 440. Network interface 440 represents an interface for sending and/or receiving data on different kinds of networks (e.g., PSTN, TCP/IP, LAN, WAN, Internet, satellite transmissions, etc.) and is not limited to any particular type of network communication. Also note, program storage unit 480 represents any form of non-volatile storage including, but not limited to, all forms of optical and magnetic storage elements including solid-state storage.

Program control device 410 may be included in different kinds of video decoding devices (e.g., cell phones, personal digital assistants (PDAs), portable communication devices, digital video disk player, video conferencing device, satellite receiver, computer, etc.) and be programmed to perform methods in accordance with this disclosure (e.g., those illustrated in FIGS. 3A-B). Program control device 410 comprises a processor unit (PU) 420, input-output (I/O) interface 450 and memory 430. Processing unit 420 may include any programmable controller device including, for example, the Intel Core®, Pentium® and Celeron® processor families from Intel and the Cortex and ARM processor families from ARM. (INTEL CORE, PENTIUM and CELERON are registered trademarks of the Intel Corporation. CORTEX is a registered trademark of the ARM Limited Corporation. ARM is a registered trademark of the ARM Limited Company.) Memory 430 may include one or more memory modules and comprise random access memory (RAM), read only memory (ROM), programmable read only memory (PROM), programmable read-write memory, and solid state memory. One of ordinary skill in the art will also recognize that PU 420 may also include some internal memory including, for example, cache memory.

In one embodiment, video decoding device 400 may represent an end point of a video conferencing network connected via Ethernet and/or public switched telephone network (PSTN) (among other types of networking technologies) via switch 442. In another embodiment, video decoding device 400 may represent a satellite receiver to receive digital satellite signals via satellite dish 441. An exemplary satellite receiver may comprise multiple network interfaces 440 (e.g., one to receive signal from satellite dish 441, and another to connect to a phone line or internet for outbound communication with the satellite provider). In yet another embodiment, video decoding device 400 may represent a digital video disc (DVD) player configured primarily to play video data read from PSD 480.

Aspects of some of the disclosed embodiments are described as a method of control or manipulation of data, and may be implemented in one or a combination of hardware, firmware, and software. Embodiments of the invention may also be implemented as instructions stored on a machine-readable medium, which may be read and executed by at least one processor to perform the operations described herein. A machine-readable medium may include any mechanism for tangibly embodying information in a form readable by a machine (e.g., a computer). For example, a machine-readable medium (sometimes referred to as a program storage device or a computer readable medium) may include read-only memory (ROM), random-access memory (RAM), magnetic disc storage media, optical storage media, flash-memory devices, electrical, optical, and others.

In the above detailed description, various features are occasionally grouped together in a single embodiment for the purpose of streamlining the disclosure. This method of disclosure is not to be interpreted as reflecting an intention that the claimed embodiments of the subject matter require more features than are expressly recited in each claim.

Various changes in the details of the illustrated operational methods are possible without departing from the scope of the following claims. For instance, time chart steps of FIGS. 3A-B may perform the identified steps in an order different or via a different splitting technique from that disclosed here. Alternatively, some embodiments may combine the activities described herein as being separate steps. Similarly, one or more of the described steps may be omitted, depending upon the specific operational environment the method is being implemented in. In addition, acts in accordance with FIGS. 3A-B may be performed by a programmable control device executing instructions organized into one or more program modules. A programmable control device may be a single computer processor, a special purpose processor (e.g., a digital signal processor, “DSP”), a plurality of processors coupled by a communications link or a custom designed state machine. Custom designed state machines may be embodied in a hardware device such as an integrated circuit including, but not limited to, application specific integrated circuits (“ASICs”) or field programmable gate array (“FPGAs”). Storage devices, sometimes called computer readable medium, suitable for tangibly embodying program instructions include, but are not limited to: magnetic disks (fixed, floppy, and removable) and tape; optical media such as CD-ROMs and digital video disks (“DVDs”); and semiconductor memory devices such as Electrically Programmable Read-Only Memory (“EPROM”), Electrically Erasable Programmable Read-Only Memory (“EEPROM”), Programmable Gate Arrays and flash devices. Video image coprocessors may be High Definition Video Image Coprocessor (HDVICP) as shown in the example DM6467 100, a digital signal processor (DSP), or a general purpose processor programmed with multimedia acceleration extension instructions as known to those of ordinary skill in the art (e.g., Streaming SIMD Extension).

It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein”.

What is claimed is:

1. A method of decoding video data on a programmable processing device with a plurality of video image coprocessors, the method comprising:
receiving video data from an input source;
decoding a first top portion of a first even numbered frame on a first video image coprocessor;
decoding a first bottom portion of a first even numbered frame on the first video image coprocessor;
decoding a first top portion of a first odd numbered frame on a second video image coprocessor;
wherein the first bottom portion of the first even numbered frame is decoded concurrently with the first top portion of the first odd numbered frame; and
providing a result decoded image to a display device.

2. The method of claim 1 wherein the video data conforms to the H.264 standard.

3. The method of claim 1 wherein the plurality of video image coprocessors are on a computer chip with the programmable processing device.

4. The method of claim 1 wherein at least one of the plurality of video image coprocessors is on a separate computer chip from the programmable processing device.

5. The method of claim 1 wherein the first video image coprocessor processes odd numbered frames and the second video image coprocessor processes even numbered frames.

6. The method of claim 1 wherein the video image coprocessor is a High Definition Video Image Coprocessor (HDVICP).

7. The method of claim 1 wherein the video image coprocessor is a digital signal processor (DSP).

8. The method of claim 1 wherein the video image coprocessor is a general purpose processor with multimedia acceleration extension instructions.

9. The method of claim 1 wherein the display device is a portable communication device.

10. The method of claim 1 wherein the display device is communicatively coupled to a video conferencing endpoint.

11. The method of claim 1 wherein the display device is a computer monitor.

12. The method of claim 1 wherein the result decoded image is a 1080p60 image.

13. The method of claim 1 wherein the result decoded image is a 4K or larger image.

14. A method of decoding video data on a programmable processing device with a plurality of video image coprocessors, the method comprising:
decoding a first quadrant of a first even numbered frame on a first video image coprocessor;
decoding a first quadrant of a first odd numbered frame on a second video image coprocessor;
decoding a first quadrant of a second even numbered frame on a third video image coprocessor;
decoding a first quadrant of a second odd numbered frame on a fourth video image coprocessor;
wherein the first quadrant of the first odd numbered frame is decoded concurrently with the second quadrant of the first even numbered frame; the first quadrant of a second even numbered frame is decoded concurrently with second quadrant of first odd numbered frame and third quadrant of first even numbered frame; the first quadrant of a second odd numbered frame is decoded currently with the second quadrant of second even numbered frame and third quadrant of first odd numbered frame and fourth quadrant of first even numbered frame.

15. The method of claim 14 wherein each quadrant are split via a functional splitting technique

16. A video decoding device comprising:
a programmable processing device communicatively coupled to a display device;
a network interface; and
a memory;
wherein the programmable processing device is configured to perform the method of the method comprising:
receiving video data from an input source;
decoding a first top portion of a first even numbered frame on a first video image coprocessor;
decoding a first bottom portion of a first even numbered frame on the first video image coprocessor;
decoding a first top portion of a first odd numbered frame on a second video image coprocessor;
wherein the first bottom portion of the first even numbered frame is decoded concurrently with the first top portion of the first odd numbered frame; and
providing a result decoded image to a display device.

17. The video decoding device of claim 16 wherein the plurality of video image coprocessors are on a computer chip with the programmable processing device.

18. The video decoding device of claim 16 wherein at least one of the plurality of video image coprocessors is on a separate computer chip from the programmable processing device.

19. The video decoding device of claim 16 wherein the first video image coprocessor processes odd numbered frames and the second video image coprocessor processes even numbered frames.

20. The video decoding device of claim 16 wherein the video image coprocessor is a High Definition Video Image Coprocessor (HDVICP).

21. The video decoding device of claim 16 wherein the video image coprocessor is a digital signal processor (DSP).

22. The video decoding device of claim 16 wherein the video image coprocessor is a general purpose processor with multimedia acceleration extension instructions.

23. The video decoding device of claim 16 wherein the display device is a portable communication device.

24. The video decoding device of claim 16 wherein the display device is communicatively coupled to a video conferencing endpoint.

25. The video decoding device of claim 16 wherein the display device is a computer monitor.

26. The video decoding device of claim 16 wherein the result decoded image is a 1080p60 image.

27. The video decoding device of claim 16 wherein the result decoded image is a 4K or larger image.

28. A video decoding device comprising:
a programmable processing device communicatively coupled to a display device;
a network interface; and
a memory;
wherein the programmable processing device is configured to perform the method of the method comprising:
decoding a first quadrant of a first even numbered frame on a first video image coprocessor;
decoding a first quadrant of a first odd numbered frame on a second video image coprocessor;
decoding a first quadrant of a second even numbered frame on a third video image coprocessor;
decoding a first quadrant of a second odd numbered frame on a fourth video image coprocessor;
wherein the first quadrant of the first odd numbered frame is decoded concurrently with the second quadrant of the first even numbered frame; the first quadrant of a second even numbered frame is decoded concurrently with second quadrant of first odd numbered frame and third quadrant of first even numbered frame; the first quadrant of a second odd numbered frame is decoded currently with the second quadrant of second even numbered frame and third quadrant of first odd numbered frame and fourth quadrant of first even numbered frame.

29. The video decoding device of claim 28 wherein the each quadrant is split via a functional splitting technique.

30. A program storage device with instructions for a programmable control device stored thereon to cause a programmable processing device with a plurality of video image coprocessors to perform a method of decoding video data, the method comprising:
receiving video data from an input source;
decoding a first top portion of a first even numbered frame on a first video image coprocessor;
decoding a first bottom portion of a first even numbered frame on the first video image coprocessor;
decoding a first top portion of a first odd numbered frame on a second video image coprocessor;
wherein the first bottom portion of the first even numbered frame is decoded concurrently with the first top portion of the first odd numbered frame; and
providing a result decoded image to a display device.
